(19) United States
(12) Patent Application Publication
(10) Pub. No.: US 2013/0163861 A1
(43) Pub. Date: Jun. 27, 2013

(54) PIXEL FLOW PROCESSING APPARATUS WITH INTEGRATED CONNECTED COMPONENTS LABELING

(71) Applicants: Vagelis Mariatos, Patras (GR); Kostas Adaos, Patras (GR)

(72) Inventors: Vagelis Mariatos, Patras (GR); Kostas Adaos, Patras (GR)

(21) Appl. No.: 13/332,967

(22) Filed: Dec. 21, 2011

(51) Int. Cl. G06K 9/54

(52) U.S. Cl. 382/162

(57) ABSTRACT

An apparatus for efficient processing of images that are expressed as flows of pixels is disclosed. The proposed pixel flow processor consists of a number of readout units each of them capable of reading images as continuous flows of pixels and flows of pixels provided in bursts, a plurality of pixel flow output units each of them capable of generating images, at least one pixel processing pipeline implementing functions like color conversion, color balancing, scaling and feature extraction, and at least one component labeling unit. This apparatus can be further enhanced with an integral image calculation unit. The apparatus provides output image as continuous flows of pixels and flows of pixels provided in bursts, which can become input to equivalent structures or stored to bus-accessible devices.

### BACKGROUND OF THE INVENTION

The disclosed invention is in the field of image processing and more specifically in the capture, processing and storage of array images. Array image are digital representation of visual data that are organised in frames of picture-elements, or pixels. Each pixel has a digital value that corresponds to one or more channels of information related to the visual content of the location of the said pixel. In many—but not all—cases, the images are generated by an image sensor, an integrated CCD or CMOS device which is read through a pixel-flow decoding circuit. Such circuits have been proposed in document like U.S. Pat. No. 7,391,437.

As proposed in documents such as U.S. Pat. No. 3,971,065 the array can consist of pixels each having information about a different color channel. The missing color information for a location can be inferred by the color channel values of its neighbours through a procedure known as de-mosaicing.

Architectures that process array images have been used since the first digital images were captures by CCD sensors. Most of these architectures process the pixels via a pipeline, i.e. a structure that performs one operation on a pixel while the next step performs another operation on the previous pixel. This method increases the throughput and requires smaller temporary memory structures. Implementations of this approach have been proposed since 1988 in U.S. Pat. No. 5,046,190, and Patent Application No. US 2003/0007703. Other documents that contain descriptions of an image processing pipeline include U.S. Pat. No. 5,852,742 and U.S. Pat. No. 5,915,079. This architecture solves in a satisfactory manner the problem of receiving and preprocessing images from array sensors, specifically when the following steps are image enhancement or image and video compression.

Another class of applications in the field of image processing is that of visual perception, where image data is analyzed in order to detect objects or shapes. Traditional image processing pipelines are not a big help in the acceleration of such algorithms, although many resources are also spent on processing of pixel flows. Two major data structuring methods applied on pixel flows that are used for object and shape detection are Connected Components and Integral Images.

Connected Components (see FIG. 7) are groups of pixels in an image that have a common property and are connected to each other. The main usage of connected components is the detection of binary large objects, also called BLOBs, in an image. BLOBs can then be handled by software for detecting the location, the shape, the size and other properties of actual objects. In documents such as Patent Applications No. US 2009/0309979, No. US 2009/0196502 and No. US 2009/0087088, various methods for labeling pixels based on pixel-level features are presented. The obvious direct connected component labeling method can also be applied if a continuous pixel flow is available. In this case a second step that would merge linked labels might be required by some BLOB-detection software implementations.

Integral Images (see FIG. 6) are images where each current location holds the sum of values of all pixels on the top and to the left of the current location. The usage of Integral Images for detection of faces or other knows shapes has been proposed in documents such as Patent Applications No. US 2010/0128993 and No. US 2010/0111446 and U.S. Pat. No. 7,020,337, U.S. Pat. No. 7,110,575 and U.S. Pat. No. 7,315,631. All implementations presented are based on software, however the hardware implementation is obvious if the pixels are available as a continuous flow as documented in Patent Application No. US 2010/0238312 where an image sensor having output of integral image is disclosed.

The current state of the art in image processing supports pixel-flow handling, acceleration for algorithms that detect object and shapes as well as preprocessing at the pixel level of the images. However, all proposed solutions do not take advantage of some generic characteristics that will allow building a more efficient and reusable image processing unit, as the one disclosed with this application.

### SUMMARY OF THE INVENTION

The characteristic of an image that is presented to the processing medium in the form of a continuous pixel flow is that the flow itself contains all structural information like resolution and color channels. It is therefore straightforward to connect many processing steps that can be applied on the pixel flow, each step generating a modified image as in the case of the processing pipelines, generating a new type of image as in the case of integral images or generating labels for each pixels as in the case of connected component labeling.

The proposed apparatus takes advantage of this characteristic and provides a module which can be used one or more times in a system for accelerating all mentioned functions directly on the pixel flow. Furthermore, the proposed apparatus is capable of generating pixel flows from images stored in memory.

The disclosed pixel flow processing apparatus is a self-contained unit that can be used to receive image streams, to generated image streams, to read images stored in bus-attached memory and to store image streams in bus-attached memory. The said pixel flow processor prepares images for further analysis by other units or programs.

The disclosed pixel flow processor consists of a number of pixel flow input units, a number of pixel flow output units, an image processing pipeline, a connected component labeling unit and an integral image calculation unit. Two or more of the disclosed pixel flow processors can be used in the same system, connected through a shared bus, through direct pixel flow channels or using a combination of both of the said connection types.

In one embodiment, the disclosed apparatus will be able to run, without relying on other resources, the following operations:
(a) read red, green and blue pixels from an image sensor
(b) interpolate missing color channels for each pixel location
(c) perform image scaling
(d) apply white balance correction
(e) convert to a luminance, chrominance color space for further processing by compression algorithms
(f) detect pixels that correspond to color tones of the human skin
(g) label connected regions of skin-tone pixels for further processing by face detection and gesture detection algorithms
(h) store in a bus-attached memory an integral image for further processing by face detection algorithms

### BRIEF DESCRIPTION OF THE DRAWINGS

FIG. 1 shows an example system which can be built by using the proposed apparatus

FIG. 2 shows a top level block diagram of the proposed apparatus

FIG. 3 shows an embodiment of the pixel processing pipeline unit where all possible functions are supported.

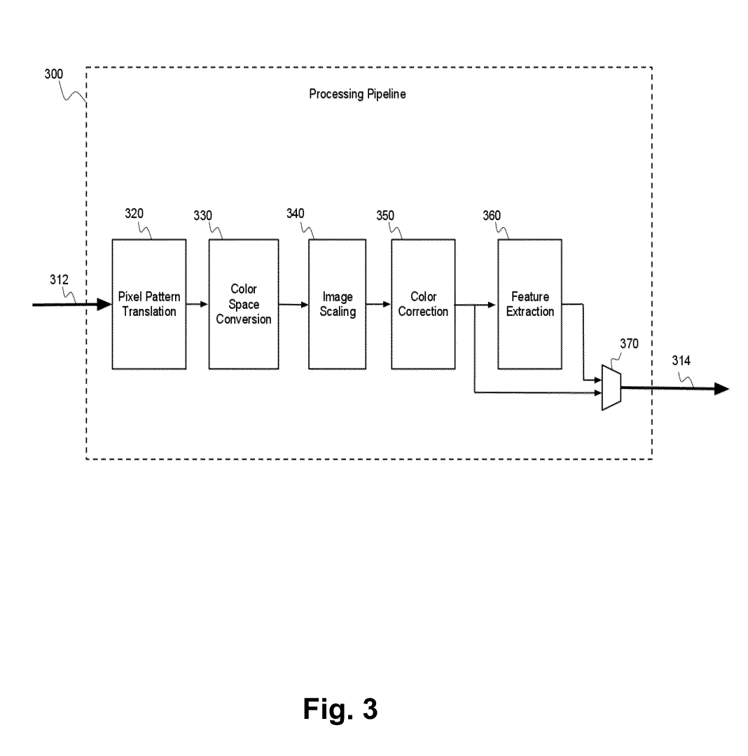

FIG. 4 contains drawing that explain in more detail the steps of the said pixel processing pipeline unit.

FIG. 5 shows the signals that constitute a pixel flow.

FIG. 6 presents the concept of an integral image

FIG. 7 is used to explain the component connection method

### DETAILED DESCRIPTION OF THE INVENTION

### Usage

The disclosed apparatus is preferably—but not exclusively—used as part of a system-on-chip, for acceleration of functions related to processing of image streams.

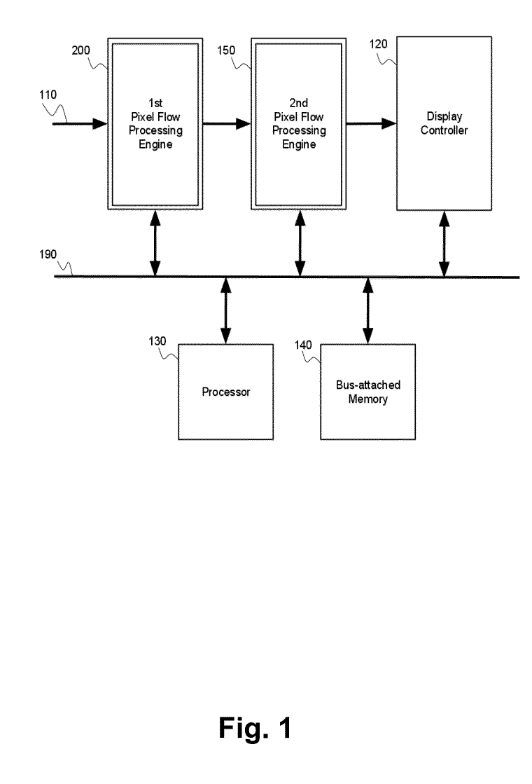

The example diagram of FIG. 1 shows a system that can be constructed by using two of the said pixel flow processors.

In the example of FIG. 1, the image is provided through an interface 110 to an external image sensor. A typical image sensor interface that can be used with this system sends an image as a continuous stream of pixels, each pixel using an of N-bit signals (e.g. for pixels with values 0 . . . 255, N will equal 8), synchronizing to image boundaries through a frame valid signal and to line boundaries through a line valid signal. All signals are synchronized though a clock signal.

In the example of FIG. 1, a first embodiment of the disclosed pixel flow processor 200 reads the said input image. This first pixel flow processor will perform image capture and preprocessing at the pace determined by the speed of the image sensor. For every image received from the sensor a component-labeled image will be stored to memory 140 and the preprocessed image will be forwarded.

In the example of FIG. 1, a second embodiment of the disclosed pixel flow processor 150 is reading the output of the first processor 200. The second pixel flow processor will use the preprocessed images and create the integral image representation. The integral image will be stored in memory 140 while the actual pixel flow will be scaled and provided directly for display via the controller 120.

In the example of FIG. 1, the system units are connected to each other via a shared bus 190 medium. The bus can be any shared bus that supports multiple masters and multiple slaves, for instance AHB, AXI or PCI. The bus must perform arbitration and will be better utilized if it supports burst read and write accesses.

In the example of FIG. 1, a generic processor 130 is attached to the said bus. The processor can be any processor core, for instance ARM, MIPS or SPARC. It is used for configuration of the two pixel flow processing engines and for executing in software image processing and recognition algorithms. For instance, the processor can read the component-labeled image that was generated by the first 200 engine and detect binary large objects (or BLOBs) in it. It can also use the integral image stored by the second 150 engine and detect specific objects like faces.

In the example of FIG. 1, images and other data are stored in a memory device 140 attached to the shared bus. The memory device must have enough capacity to store multiple images. It can be implemented with any possible random-access-memory (RAM) technique, for instance as on-chip memory or as an external SRAM or SDRAM memory that is connected to the bus via a controller unit. The access to the memory can be accelerated with the usage of cache memories and burst read/write commands.

In order to display images processed by the said example system of FIG. 1, a display controller 120 can be attached to the bus. The display will show images created by the processor 130 in the memory 140. It will also show live images as they are generated by the second processing engine 150.

### Structure

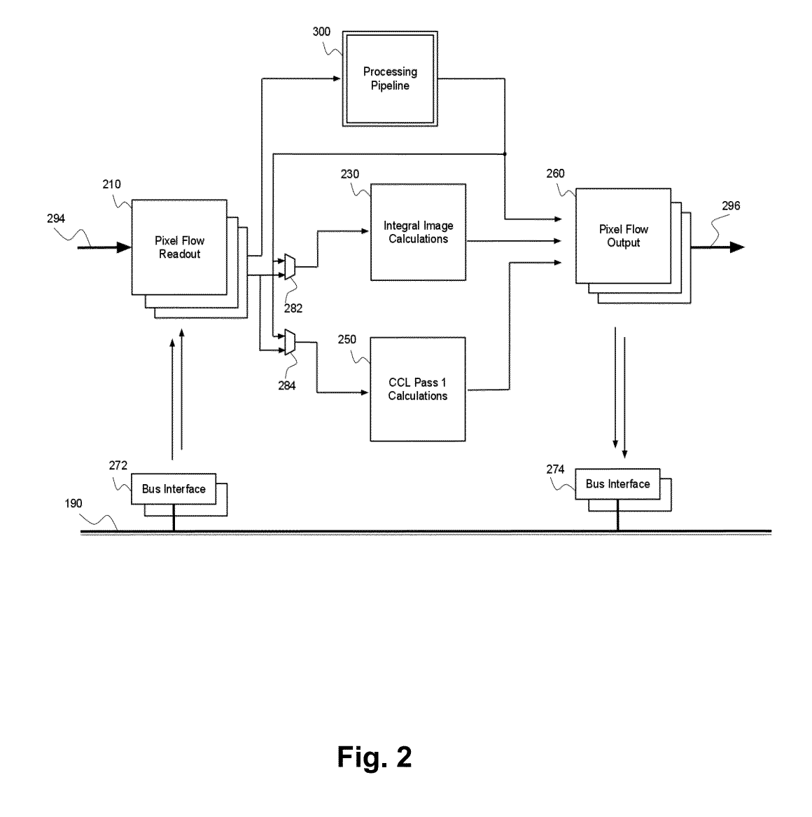

The disclosed apparatus is hereby described by reference to the block diagram of FIG. 2. This block diagram shows the units that constitute the said pixel flow processor (200,150 in FIG. 1). The block diagram also shows the connections that carry pixel flows of various structures between the units. The pixel flow processor is depicted as a data-flow with inputs, processing and outputs as follows:

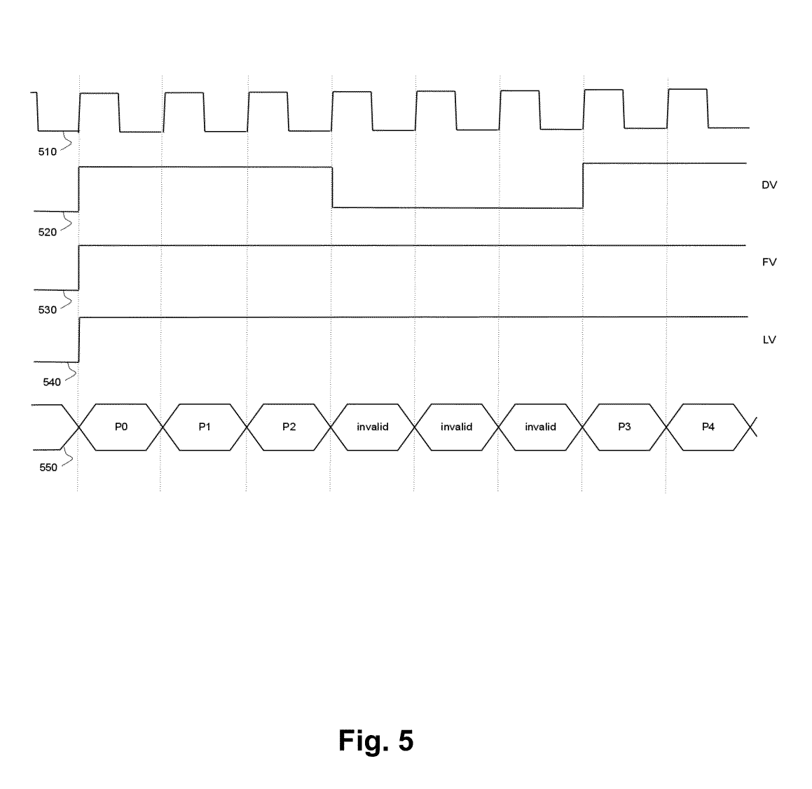

The input for all processing is performed by one or more pixel flow readout units 210. For a complete implementation of the disclosed apparatus, at least two pixel flow readout units are required, one attached to the shared bus 190 and another that reads continuous flows 294. The readout unit synchronises to frame and line boundaries 530, 540 of the image and outputs a continuous pixel flow where a data-valid 520 signal is used to denote that at a current clock 510 tick the flow does not contain a pixel 550. One implementation of this flow can be as shown in FIG. 5, other equivalent implementations can be used.

The output of all processing is generated by one or more pixel flow output units 260. For a complete implementation of the disclosed apparatus, at least two pixel flow output units are required, one attached to the shared bus 190 and another that generates continuous flows 296. The said output unit reads a pixel flow equivalent to the one shown in FIG. 5.

The pixel flow input 210 and output 260 units can read and write images from bus-attached devices. To do so, they are connected to a shared bus 190 via an image reading bus interface unit 272 and an image writing bus interface unit 274. The bus interface units are bus master devices that access other devices, like 140 memories, via read and write bus access cycles. The bus interface device that reads 272 will fetch an entire image region by a sequence of bus read commands and give it in the form of a pixel flow to the readout unit 210. The read sequences are be constructed by single reads and by a number of multiple reads, i.e. burst reads. The bus interface unit that writes 274 will get a continuous pixel flow as generated by the output unit 260 and write it via a sequence of bus write commands to memory or other bus-attached device as a complete image region. The write sequences are constructed by single writes and by a number of multiple writes, i.e. burst writes.

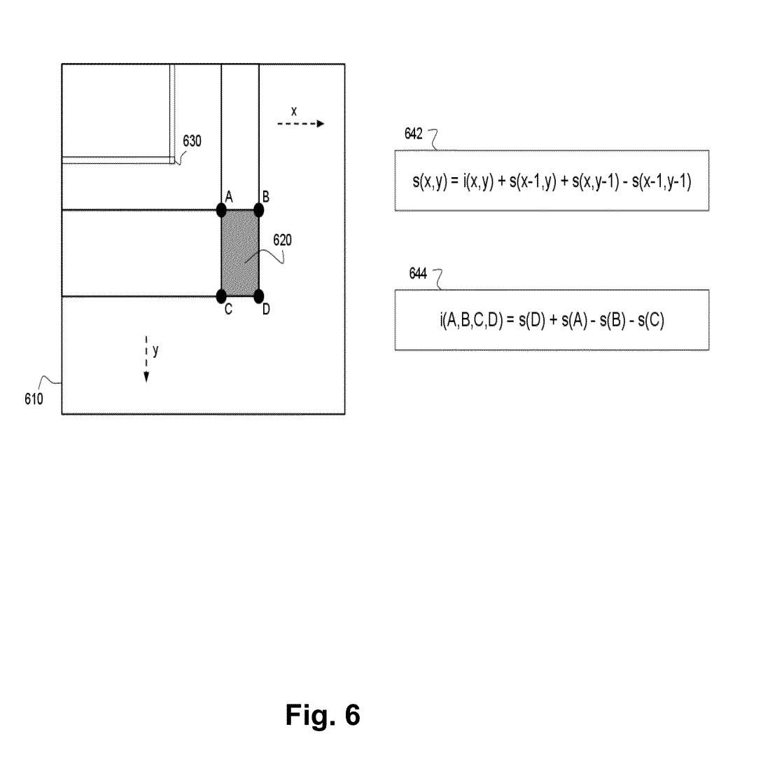

The pixel flow provided by the input 210 unit and by the processing pipeline 300 is connected to a unit 230 that calculates and generates in the form of a pixel flow the integral image. An integral image, also known as a summed area table, is defined as shown in FIG. 6 as an image where each pixel location has a value that is proportional to the sum of values of pixel in the original image that lie “above” and “to-the-left”, i.e. as a sum of all pixels with row and column index smaller that the said pixel's row and column.

The pixel flow provided by the input 210 unit and by the processing pipeline 300 is connected to a unit 250 that calculates and generates in the form of a pixel flow an image with labeled pixels, each label corresponding to an arbitrary connected region in the original image.

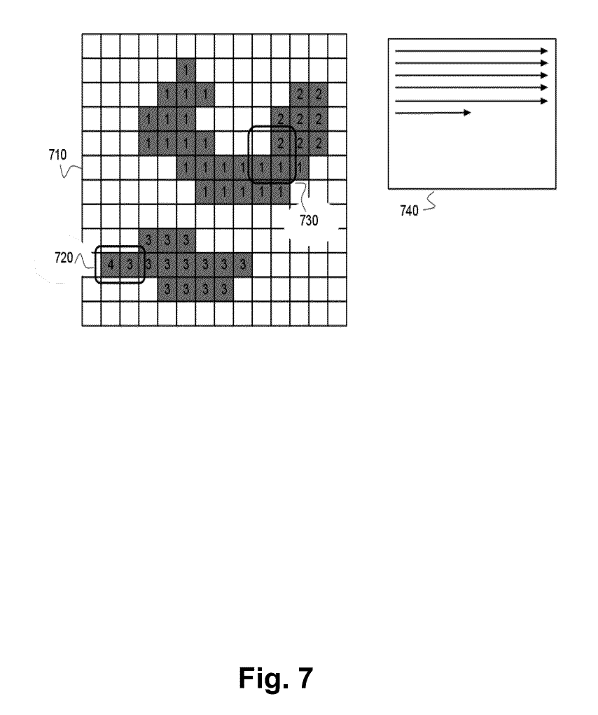

FIG. 7 shows how pixels from an image 710 marked, for example by the threshold function 361 in the feature extraction step 360 of the processing pipeline 300, are labeled. The image scanning order 740 checks for each current valid pixel if valid pixels exist in it;s already scanned neighborhood. If so, the label from the neighborhood pixels is copied to the said current pixel, otherwise a new label is created. This procedure can yield multiple labels for each connected region 720, 730, which are detected and stored in a linked list for further processing by other units or software.

The pixel flow received by the input 210 units is provided as input to a processing pipeline block 300. The said processing pipeline consists of means to modify the pixel values in order to prepare them for further processing. It is structured as a data-flow machine with processing steps 320, 330, 340, 350, 360.

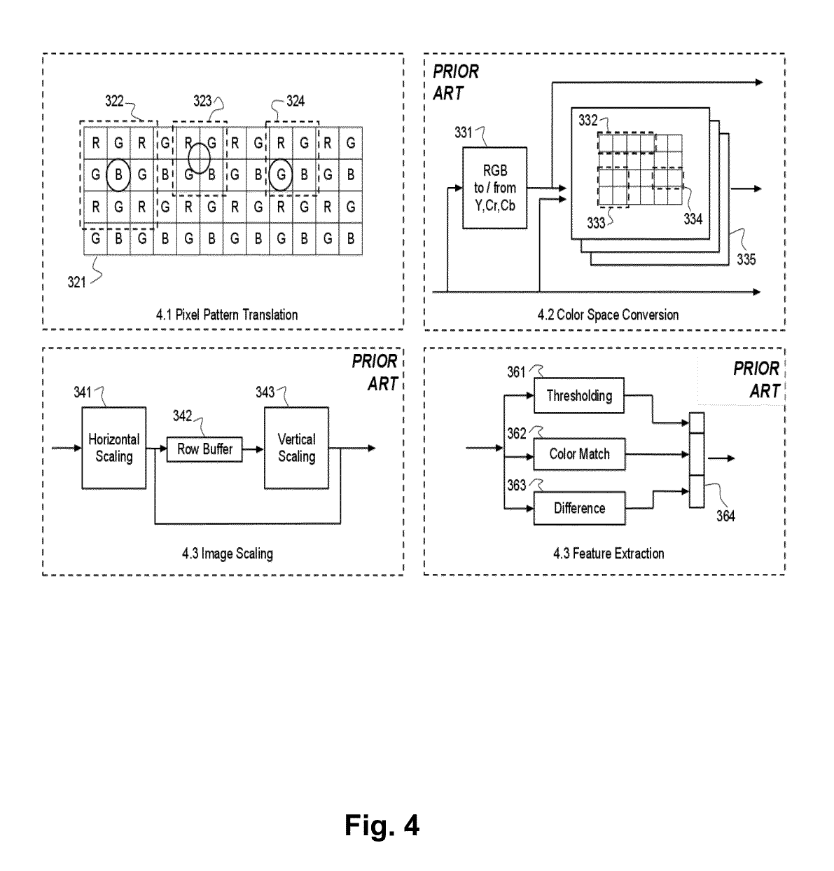

The first processing step of the said processing pipeline is pixel pattern translation 320. This step reads the pixel flow 312 and translates it into standard pixel flow with each pixel having all color channels. As shown in FIG. 4.1 an embodiment of this step can translate the widely used RGGB Bayer pattern 321 (as described in U.S. Pat. No. 3,971,065) and generate images where each pixel's color components [R,G,B] will be based on a neighborhood of 9 pixels 322, alternatively on a neighborhood of four pixels 323 or a direct copy of values from adjacent pixels 324. Other pixel patterns, for example RBGG, YUYV, RGGR/BGGB, can also be supported by embodiments of the said pattern translation step.

The second processing step is color space conversion 330. This step reads pixels as prepared by the pattern translation step 320 and converts the values of their color channels into a different color space. It contains means for support for sub-sampling of selected color channels. In one embodiment shown in FIG. 4.2, the color space is changed by a unit 332 that converts from [R,G,B] to [Y,Cb,Cr] and reverse. Selected color channels, for instance the chrominance channels Cb and Cr, are then sub-sampled for reducing the size of the image data. In the shown embodiment, sub-sampling of 4 columns 332, 2 columns 334 and 2 columns by 2 rows 333 is implemented.

The third step is image scaling 340. This step reads the image and outputs a new pixel flow corresponding to an image with different dimensions. In one embodiment shown in FIG. 4.3. the scaling step is implemented by a horizontal 341 scaling unit, a buffer 342 to store rows of pixels and a vertical 343 scaling unit.

The fourth step 350 is primary intended to be used for applying color correction operations like white balance on the input images. It is a rather straightforward block that rescales each color component of each pixel by a factor which is externally provided, either by software or by an automatic white balance estimator.

The fifth step 360, feature extraction, does not alter the color channels of each pixel, but rather reads them in order to calculate other pixel features that may be used in further processing. In one embodiment shown in FIG. 4.4, the extracted features are a comparison against a threshold value 361, a test if a pixel is within a defined color range 362, and the difference of a pixel from a predefined value 363. Each feature is copied in a specified bit code that forms 364 the output of the feature extraction step.

Before exiting the processing pipeline, a structure 370, based on multiplexers selects which channels are mapped to which channels of the output pixel flow 314. This allows for creating configurable pixel structures, as best suited for each specific image processing algorithm.

DISCLAIMER: The work that led to the development of this invention, was co-financed by Hellenic Funds and by the European Regional Development Fund (ERDF) under the Hellenic National Strategic Reference Framework (NSRF) 2007-2013, according to Contract no. MICRO2-09 of the Project “SC80” within the Programme “Hellenic Technology Clusters in Microelectronics—Phase-2 Aid Measure”.

What is claimed is:

1. An apparatus for processing images characterised by
(a) each said image is provided as a sequence of pixels of a given number of segments, said image height, and a given length for each segment, said image width, where
each pixel can be effectively indexed by its segment, said vertical location, and its index within the segment, said horizontal location
each pixel is composed by at least one integer value, said channel with at least one of the channels in at least one of the pixel flows representing color information, said color channel
(b) the apparatus being composed of
a plurality of pixel flow readout units each of them capable of reading continuous flows of pixels and flows of pixels provided in bursts
a plurality of pixel flow output units each of them capable of generating continuous flows of pixels and flows comprised by bursts of pixels
at least one pixel processing pipeline capable of regenerating full color pixels from color-pattern pixel flows
at least one component labeling unit for generating labeled pixels where each pixel is labeled based on connectedness to other already labeled pixels which are preceding said pixel in the flow
connections that send received pixel flow from one of said readout units to the said processing pipeline and the said component labeling unit
connections that send full color pixel flows generated by said processing pipeline to the said component labeling unit and the said flow output units and
connection that sends labeled pixels from said component labeling unit to the said flow output units

2. The apparatus of claim 1, where
pixel flows comprised by bursts are generated by at least one bus read interface unit connected to a shared bus and
at least one bus write interface unit stores pixel flows comprised by bursts to a bus attached device
the pixel flow generated by said bus read interface is provided as input to one of the said pixel flow readout units
the pixel flow generated by said pixel flow output units is provide as input to one of the said but write interfaces

3. The apparatus of claim 1, where
an integral image calculation unit is used to generate pixel flows where each pixel is labeled as the integral of all preceding pixels in the pixel flow for which the horizontal and vertical location is smaller than the said pixel
at least one connection exists that brings pixel flows from said readout units and said processing pipeline
at least one connection sending labeled pixel flows from the said integral image calculation unit to on of the said pixel flow output units

4. The apparatus of claim 1 where the processing pipeline unit contains a function that implements color space conversion

5. The apparatus of claim 1 where the processing pipeline unit contains a function that implements image scaling by generating at its output pixel flows of image height and image width different from the input flows height and width

6. The apparatus of claim 1 where the processing pipeline unit contains a function that implements pixel value scaling per color channel

7. The apparatus of claim 4 where the processing pipeline unit contains a function that implements pixel feature extraction, labeling each pixel as said pixel's value belonging or not to a given luminance and chroma region

8. The apparatus of claim 7 where the labeled pixels generated by the said pixel feature extraction function of the said processing pipeline are provided as input to the said component labeling unit.
